(19) United States
(12) Patent Application Publication
(10) Pub. No.: US 2023/0300470 A1
(43) Pub. Date: Sep. 21, 2023

(54) TECHNIQUES FOR PRODUCING GLINTS AND IRIS ILLUMINATION FOR EYE TRACKING

(71) Applicant: FACEBOOK TECHNOLOGIES, LLC, Menlo Park, CA (US)

(72) Inventors: Ann RUSSELL, San Jose, CA (US); Eredzhep MENUMEROV, San Jose, CA (US); Kun LIU, Redwood City, CA (US)

(21) Appl. No.: 17/825,967

(22) Filed: May 26, 2022

Related U.S. Application Data
(60) Provisional application No. 63/306,436, filed on Feb. 3, 2022.

(51) Int. Cl. H04N 5/235; H04N 5/225; G06T 7/292; G02B 27/01; G02B 27/00

(52) U.S. Cl. CPC H04N 5/2354; G02B 27/0093; G02B 27/0172; G06T 7/292; H04N 5/2254; H04N 5/2256; G02B 2027/0138; G02B 2027/0178; G06T 2207/10152; G06T 2207/30201

(57) ABSTRACT

An eye tracking system includes a smaller form factor and permits the eyes of a viewer to be tracked more accurately and/or with a better signal-to-noise ratio relative to conventional eye tracking systems. The eye tracking system can include multiple light sources configured to illuminate an eye. Either a lenslet array or diffuser is disposed in a path of light emitted by each light source included in the one or more light sources, or the path of light emitted by each light source included in the one or more light sources is unobstructed by any optical element. In addition, the light sources can include Lambertian light sources that emit light uniformly in all directions, narrow field of view (FOV) light sources, and/or a combination thereof in order to provide flood illumination to distinguish between an iris and a pupil of the eye and/or to generate glints that can be used to track the eye over time

### CROSS-REFERENCE TO RELATED APPLICATIONS

This application claims priority benefit of the U.S. Provisional Pat. Application titled, “TECHNIQUES FOR PRODUCING GLINTS AND IRIS ILLUMINATION FOR EYE TRACKING,” filed on Feb. 3, 2022, and having Serial No. 63/306,436. The subject matter of this related application is hereby incorporated herein by reference.

### BACKGROUND

### Field of the Various Embodiments

The present disclosure relates generally to eye tracking systems, and more specifically, to techniques for producing glints and iris illumination for eye tracking.

### Description of the Related Art

Artificial reality systems display content that may include completely generated content or generated content combined with captured (e.g., real-world) content. An artificial reality system can include a display device that emits light and optical elements that act on the emitted light and/or real-world light to modulate, combine, and redirect light towards the eyes of a viewer.

In order to redirect light towards the eyes of a viewer, artificial reality systems include eye tracking systems to obtain information about the positions of the eyes, such as information about angles of the eye gaze. Some eye tracking systems include one or more light sources, secondary optics, and an imaging device to capture each eye. The secondary optics are optical elements mounted on top of the light sources. The light sources and secondary optics can generate glints on the eye that are monitored over time, as well as overall iris illumination (also referred to herein as “flood illumination”) for distinguishing the pupil from the iris of the eye. The position of the pupil can be tracked based on the glint positions and the detected pupil.

One drawback of the above approach for eye tracking is that the glints generated by the light sources and the secondary optics need to be tightly focused. However, using the light sources and secondary optics to generate tightly-focused glints reduces the amount of flood illumination that can be generated by the light sources and secondary optics. Accordingly, as a general matter, conventional eye tracking systems do not generate sufficiently tightly-focused glints and sufficient flood illumination to enable accurate eye tracking and a desirable signal-to-noise ratio for iris contrast.

Another drawback of the above approach for eye tracking is the combination of the light sources and the secondary optics is oftentimes relatively large in size. The size of the light sources and the secondary optics can cause the display of an artificial reality system, such as a head-mounted display (HMD), to be relatively far from the face of a viewer. As a result, the viewer can experience a reduced field of view (FOV) of the content being displayed.

As the foregoing illustrates, what is needed in the art are more effective techniques for eye tracking.

### SUMMARY

One embodiment of the present disclosure sets forth an eye tracking system. The eye tracking system includes one or more cameras, and one or more light sources configured to illuminate an eye. Either (i) at least one of a lenslet array or a diffuser is disposed in a path of light emitted by each light source included in the one or more light sources, or (ii) the path of light emitted by each light source included in the one or more light sources is unobstructed by any optical elements.

Another embodiment of the present disclosure sets forth a head-mounted display (HMD). The HMD includes an electronic display and an eye tracking system. The eye tracking system includes one or more light sources configured to illuminate an eye. Either (i) at least one of a lenslet array or a diffuser is disposed in a path of light emitted by each light source included in the one or more light sources, or (ii) the path of light emitted by each light source included in the one or more light sources is unobstructed by any optical elements.

Another embodiment of the present disclosure sets forth an eye tracking system. The eye tracking system includes one or more cameras. The eye tracking system further includes one or more first light sources, each first light source generating substantially uniform light in a plurality of directions. In addition, the eye tracking system includes one or more second light sources, each second light source generating a narrower field of view (FOV) light beam relative to each first light source.

One advantage of the eye tracking systems disclosed herein is that the eye tracking systems are more compact relative to conventional eye tracking systems. Accordingly, the disclosed eye tracking systems permit a display of an artificial reality system, such as an HMD, to be relatively close to the face of a viewer. Accordingly, the viewer can experience a larger FOV of content being displayed relative to artificial reality systems that include conventional eye tracking systems. In addition, some of the disclosed eye tracking systems produce more tightly-focused glints in conjunction with flood illumination relative to conventional eye tracking systems. Using the tightly-focused glints and the flood illumination, the eyes of a viewer can be tracked more accurately and/or with a better signal-to-noise ratio. These technical advantages represent one or more technological advancements over prior art approaches.

### BRIEF DESCRIPTION OF THE DRAWINGS

So that the manner in which the above recited features of the various embodiments can be understood in detail, a more particular description of the disclosed concepts, briefly summarized above, may be had by reference to various embodiments, some of which are illustrated in the appended drawings. It is to be noted, however, that the appended drawings illustrate only typical embodiments of the disclosed concepts and are therefore not to be considered limiting of scope in any way, and that there are other equally effective embodiments.

FIG. 1A is a diagram of a near eye display (NED), according to various embodiments.

FIG. 1B is a cross section of the front rigid body of the embodiments of the NED illustrated in FIG. 1A.

FIG. 2A is a diagram of a head-mounted display (HMD) implemented as a NED, according to various embodiments.

FIG. 2B is a cross-section view of the HMD of FIG. 2A implemented as a near eye display, according to various embodiments.

FIG. 3 is a block diagram of a NED system, according to various embodiments.

FIG. 4A illustrates a side view of an eye tracking system, according to the prior art.

FIG. 4B illustrates exemplar glints and iris illumination generated by the eye tracking system of FIG. 4A, according to the prior art.

FIG. 5 illustrates a frontal view of another eye tracking system, according to the prior art.

FIG. 6A illustrates a side view of an eye tracking system, according to various embodiments.

FIG. 6B illustrates exemplar glints and iris illumination generated by the eye tracking system of FIG. 6A, according to various embodiments.

FIG. 7A illustrates a side view of an eye tracking system, according to various other embodiments.

FIG. 7B illustrates exemplar glints and iris illumination generated by the eye tracking system of FIG. 7A, according to various embodiments.

FIG. 8A illustrates a side view of an eye tracking system, according to various other embodiments.

FIG. 8B illustrates exemplar glints and iris illumination generated by the eye tracking system of FIG. 8A, according to various embodiments.

FIG. 9A illustrates a side view of an eye tracking system, according to various other embodiments.

FIG. 9B illustrates exemplar glints and iris illumination generated by the eye tracking system of FIG. 9A, according to various embodiments.

FIG. 10A illustrates a frontal view of an eye tracking system, according to various other embodiments.

FIG. 10B illustrates a side view of a light source and a lenslet array of the eye tracking system of FIG. 10A, according to various embodiments.

FIG. 10C illustrates in greater detail a top view of a lenslet array of the eye tracking system of FIG. 10A, according to various embodiments.

FIG. 11 illustrates a frontal view of an eye tracking system, according to various other embodiments.

FIG. 12 illustrates simulated angular positions of glints relative to a light source, according to various embodiments.

### DETAILED DESCRIPTION

In the following description, numerous specific details are set forth to provide a more thorough understanding of the various embodiments. However, it is apparent to one of skill in the art that the disclosed concepts may be practiced without one or more of these specific details.

### Configuration Overview

One or more embodiments disclosed herein relate to eye tracking systems that have a smaller form factor and permit the eyes of a viewer to be tracked more accurately and/or with a better signal-to-noise ratio relative to conventional eye tracking systems. In some embodiments, an eye tracking system includes multiple light sources configured to illuminate an eye. Either no optical elements, a diffuser, or a lenslet array are disposed in a path of light emitted by each light source. In addition, the light sources can include Lambertian light sources that emit light uniformly in all directions, narrow field of view (FOV) light sources, and/or a combination thereof in order to provide flood illumination to distinguish between an iris and a pupil of the eye and/or to generate glints that can be used to track the eye over time.

### System Overview

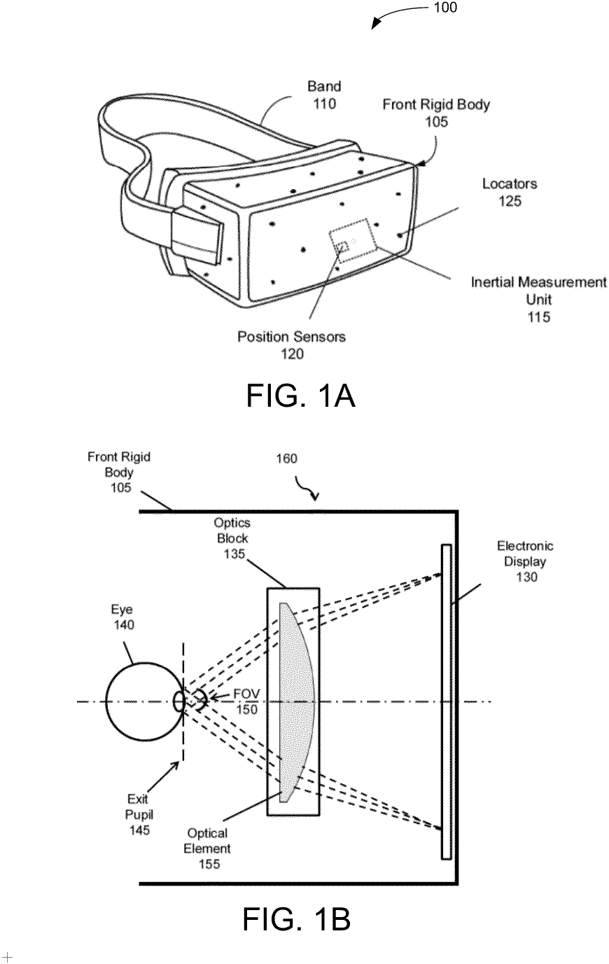

FIG. 1A is a wire diagram of a near eye display (NED) 100, according to various embodiments. As shown, the NED 100 includes a front rigid body 105 and a band 110. The front rigid body 105 includes one or more electronic display elements of an electronic display (not shown), an inertial measurement unit (IMU) 115, one or more position sensors 120, and locators 125. As illustrated in FIG. 1A, position sensors 120 are located within the IMU 115, and neither the IMU 115 nor the position sensors 120 are visible to the user. In various embodiments, where the NED 100 acts as an AR or MR device, portions of the NED 100 and/or its internal components are at least partially transparent.

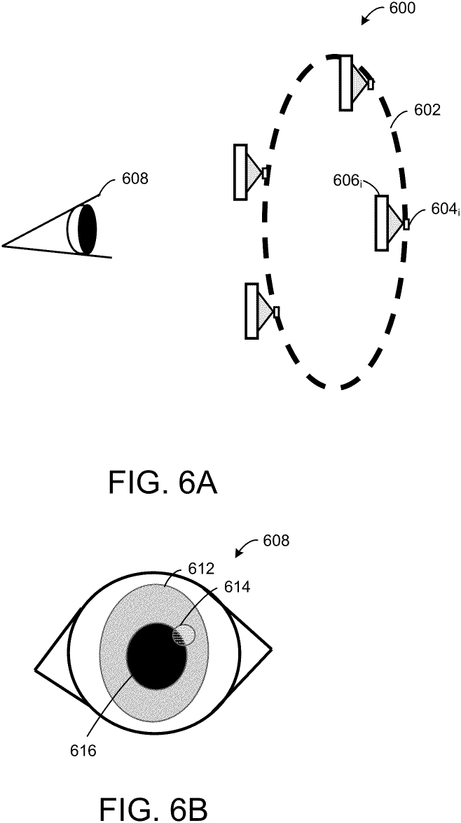

FIG. 1B is a cross section 160 of the front rigid body 105 of the embodiments of the NED 100 illustrated in FIG. 1A. As shown, the front rigid body 105 includes an electronic display 130 and an optics block 135 that together provide image light to an exit pupil 145. The exit pupil 145 is the location of the front rigid body 105 where a user’s eye 140 may be positioned. For purposes of illustration, FIG. 1B shows a cross section 160 associated with a single eye 140, but another optics block, separate from the optics block 135, may provide altered image light to another eye of the user. Additionally, the NED 100 includes an eye tracking system (not shown in FIG. 1B). The eye tracking system may include one or more sources that illuminate one or both eyes of the user. The eye tracking system may also include one or more cameras that capture images of one or both eyes of the user to track the positions of the eyes. In some embodiments, the eye tracking system can be one of the eye tracking systems 600, 700, 800, 900, 1000, or 1100, discussed in greater detail below in conjunction with FIGS. 6A-6B, 7A-7B, 8A-8B, 9A-9B, 10A-10C, and 11, respectively.

The electronic display 130 displays images to the user. In various embodiments, the electronic display 130 may comprise a single electronic display or multiple electronic displays (e.g., a display for each eye of a user). Examples of the electronic display 130 include: a liquid crystal display (LCD), an organic light emitting diode (OLED) display, an active-matrix organic light-emitting diode display (AMOLED), a QOLED, a QLED, some other display, or some combination thereof.

The optics block 135 adjusts an orientation of image light emitted from the electronic display 130 such that the electronic display 130 appears at particular virtual image distances from the user. The optics block 135 is configured to receive image light emitted from the electronic display 130 and direct the image light to an eye-box associated with the exit pupil 145. The image light directed to the eye-box forms an image at a retina of eye 140. The eye-box is a region defining how much the eye 140 moves up/down/left/right from without significant degradation in the image quality. In the illustration of FIG. 1B, a field of view (FOV) 150 is the extent of the observable world that is seen by the eye 140 at any given moment.

Additionally, in some embodiments, the optics block 135 magnifies received light, corrects optical errors associated with the image light, and presents the corrected image light to the eye 140. The optics block 135 may include one or more optical elements 155 in optical series. An optical element 155 may be an aperture, a Fresnel lens, a convex lens, a concave lens, a filter, a waveguide, a Pancharatnam-Berry phase (PBP) lens or grating, a color-selective filter, a waveplate, a C-plate, or any other suitable optical element 155 that affects the image light. Moreover, the optics block 135 may include combinations of different optical elements. One or more of the optical elements in the optics block 135 may have one or more coatings, such as anti-reflective coatings.

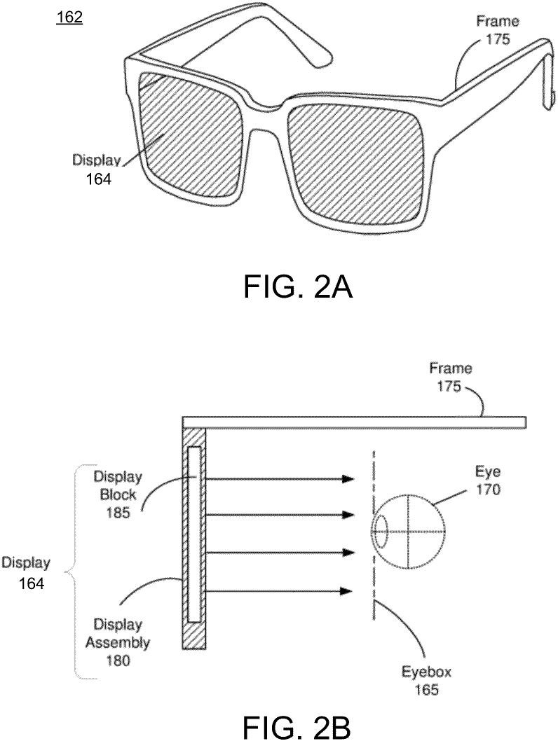

FIG. 2A is a diagram of an HMD 162 implemented as a NED, according to various embodiments. As shown, the HMD 162 is in the form of a pair of augmented reality glasses. The HMD 162 presents computer-generated media to a user and augments views of a physical, real-world environment with the computer-generated media. Examples of computer-generated media presented by the HMD 162 include one or more images, video, audio, or some combination thereof. In some embodiments, audio is presented via an external device (e.g., speakers and headphones) that receives audio information from the HMD 162, a console (not shown), or both, and presents audio data based on audio information. In some embodiments, the HMD 162 may be modified to also operate as a VR HMD, a MR HMD, or some combination thereof. The HMD 162 includes a frame 175 and a display 164. As shown, the frame 175 mounts the NED to the user’s head, while the display 164 provides image light to the user. The display 164 may be customized to a variety of shapes and sizes to conform to different styles of eyeglass frames.

FIG. 2B is a cross-section view of the HMD 162 of FIG. 2A implemented as a NED, according to various embodiments. This view includes frame 175, display 164 (which comprises a display assembly 180 and a display block 185), and eye 170. The display assembly 180 supplies image light to the eye 170. The display assembly 180 houses display block 185, which, in different embodiments, encloses the different types of imaging optics and redirection structures. For purposes of illustration, FIG. 2B shows the cross section associated with a single display block 185 and a single eye 170, but in alternative embodiments not shown, another display block, which is separate from display block 185 shown in FIG. 2B, provides image light to another eye of the user.

The display block 185, as illustrated, is configured to combine light from a local area with light from computer generated image to form an augmented scene. The display block 185 is also configured to provide the augmented scene to the eyebox 165 corresponding to a location of the user’s eye 170. The display block 185 may include, for example, a waveguide display, a focusing assembly, a compensation assembly, or some combination thereof.

HMD 162 may include one or more other optical elements between the display block 185 and the eye 170. The optical elements may act to, for example, correct aberrations in image light emitted from the display block 185, magnify image light emitted from the display block 185, some other optical adjustment of image light emitted from the display block 185, or some combination thereof. The example for optical elements may include an aperture, a Fresnel lens, a convex lens, a concave lens, a filter, or any other suitable optical element that affects image light. The display block 185 may also comprise one or more materials (e.g., plastic, glass, etc.) with one or more refractive indices that effectively minimize the weight and widen a field of view of the HMD 162.

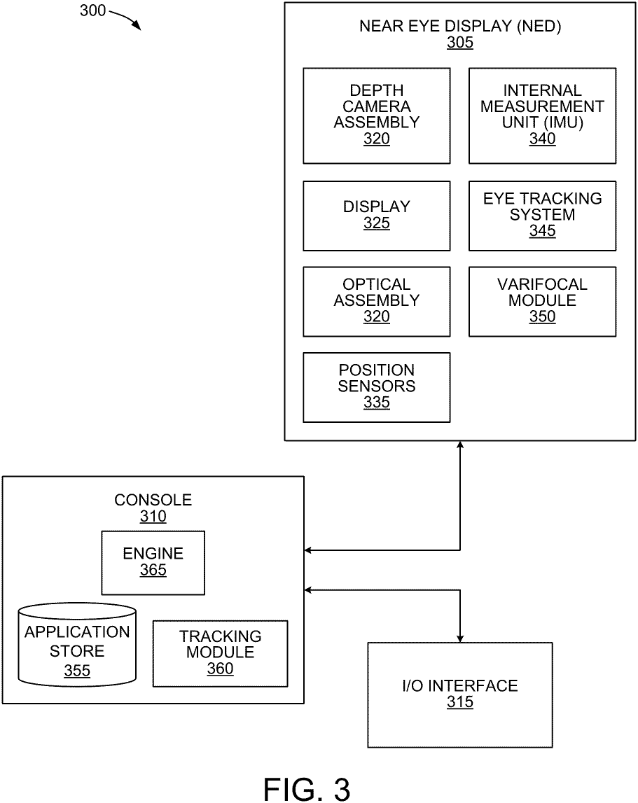

FIG. 3 is a block diagram of an embodiment of a near eye display system 300 in which a console 310 operates. In some embodiments, the NED system 300 corresponds to the NED 100 or the HMD 162. The NED system 300 may operate in a VR system environment, an AR system environment, a MR system environment, or some combination thereof. The NED system 300 shown in FIG. 3 comprises a NED 305 and an input/output (I/O) interface 315 that is coupled to the console 310.

While FIG. 3 shows an example NED system 300 including one NED 305 and one I/O interface 315, in other embodiments any number of these components may be included in the NED system 300. For example, there may be multiple NEDs 305 that each has an associated I/O interface 315, where each NED 305 and I/O interface 315 communicates with the console 310. In alternative configurations, different and/or additional components may be included in the NED system 300. Additionally, various components included within the NED 305, the console 310, and the I/O interface 315 may be distributed in a different manner than is described in conjunction with FIG. 3 in some embodiments. For example, some or all of the functionality of the console 310 may be provided by the NED 305.

The NED 305 may be a head-mounted display that presents content to a user. The content may include virtual and/or augmented views of a physical, real-world environment including computer-generated elements (e.g., two-dimensional or three-dimensional images, two-dimensional or three-dimensional video, sound, etc.). In some embodiments, the NED 305 may also present audio content to a user. The NED 305 and/or the console 310 may transmit the audio content to an external device via the I/O interface 315. The external device may include various forms of speaker systems and/or headphones. In various embodiments, the audio content is synchronized with visual content being displayed by the NED 305.

The NED 305 may comprise one or more rigid bodies, which may be rigidly or non-rigidly coupled together. A rigid coupling between rigid bodies causes the coupled rigid bodies to act as a single rigid entity. In contrast, a non-rigid coupling between rigid bodies allows the rigid bodies to move relative to each other.

As shown in FIG. 3, the NED 305 may include a depth camera assembly (DCA) 320, a display 325, an optical assembly 330, one or more position sensors 335, an inertial measurement unit (IMU) 340, an eye tracking system 345, and a varifocal module 350. In some embodiments, the display 325 and the optical assembly 330 can be integrated together into a projection assembly. Various embodiments of the NED 305 may have additional, fewer, or different components than those listed above. Additionally, the functionality of each component may be partially or completely encompassed by the functionality of one or more other components in various embodiments.

The DCA 320 captures sensor data describing depth information of an area surrounding the NED 305. The sensor data may be generated by one or a combination of depth imaging techniques, such as triangulation, structured light imaging, time-of-flight imaging, laser scan, and so forth. The DCA 320 can compute various depth properties of the area surrounding the NED 305 using the sensor data. Additionally or alternatively, the DCA 320 may transmit the sensor data to the console 310 for processing.

The DCA 320 includes a light source, an imaging device, and a controller. The light source emits light onto an area surrounding the NED 305. In an embodiment, the emitted light is structured light. The light source includes a plurality of emitters that each emits light having certain characteristics (e.g., wavelength, polarization, coherence, temporal behavior, etc.). The characteristics may be the same or different between emitters, and the emitters can be operated simultaneously or individually. In one embodiment, the plurality of emitters could be, e.g., laser diodes (such as edge emitters), inorganic or organic light-emitting diodes (LEDs), a vertical-cavity surface-emitting laser (VCSEL), or some other source. In some embodiments, a single emitter or a plurality of emitters in the light source can emit light having a structured light pattern. The imaging device captures ambient light in the environment surrounding NED 305, in addition to light reflected off of objects in the environment that is generated by the plurality of emitters. In various embodiments, the imaging device may be an infrared camera or a camera configured to operate in a visible spectrum. The controller coordinates how the light source emits light and how the imaging device captures light. For example, the controller may determine a brightness of the emitted light. In some embodiments, the controller also analyzes detected light to detect objects in the environment and position information related to those objects.

The display 325 displays two-dimensional or three-dimensional images to the user in accordance with pixel data received from the console 310. In various embodiments, the display 325 comprises a single display or multiple displays (e.g., separate displays for each eye of a user). In some embodiments, the display 325 comprises a single or multiple waveguide displays. Light can be coupled into the single or multiple waveguide displays via, e.g., a liquid crystal display (LCD), an organic light emitting diode (OLED) display, an inorganic light emitting diode (ILED) display, an active-matrix organic light-emitting diode (AMOLED) display, a transparent organic light emitting diode (TOLED) display, a laser-based display, one or more waveguides, other types of displays, a scanner, a one-dimensional array, and so forth. In addition, combinations of the displays types may be incorporated in display 325 and used separately, in parallel, and/or in combination.

The optical assembly 330 magnifies image light received from the display 325, corrects optical errors associated with the image light, and presents the corrected image light to a user of the NED 305. The optical assembly 330 includes a plurality of optical elements. For example, one or more of the following optical elements may be included in the optical assembly 330: an aperture, a Fresnel lens, a convex lens, a concave lens, a filter, a reflecting surface, or any other suitable optical element that deflects, reflects, refracts, and/or in some way alters image light. Moreover, the optical assembly 330 may include combinations of different optical elements. In some embodiments, one or more of the optical elements in the optical assembly 330 may have one or more coatings, such as partially reflective or antireflective coatings. The optical assembly 330 can be integrated into a projection assembly. In one embodiment, the optical assembly 330 includes the optics block 155.

In operation, the optical assembly 330 magnifies and focuses image light generated by the display 325. In so doing, the optical assembly 330 enables the display 325 to be physically smaller, weigh less, and consume less power than displays that do not use the optical assembly 330. Additionally, magnification may increase the field of view of the content presented by the display 325. For example, in some embodiments, the field of view of the displayed content partially or completely uses a user’s field of view. For example, the field of view of a displayed image may meet or exceed 310 degrees. In various embodiments, the amount of magnification may be adjusted by adding or removing optical elements.

In some embodiments, the optical assembly 330 may be designed to correct one or more types of optical errors. Examples of optical errors include barrel or pincushion distortions, longitudinal chromatic aberrations, or transverse chromatic aberrations. Other types of optical errors may further include spherical aberrations, chromatic aberrations or errors due to the lens field curvature, astigmatisms, in addition to other types of optical errors. In some embodiments, visual content transmitted to the display 325 is pre-distorted, and the optical assembly 330 corrects the distortion as image light from the display 325 passes through various optical elements of the optical assembly 330. In some embodiments, optical elements of the optical assembly 330 are integrated into the display 325 as a projection assembly that includes at least one waveguide coupled with one or more optical elements.

The IMU 340 is an electronic device that generates data indicating a position of the NED 305 based on measurement signals received from one or more of the position sensors 335 and from depth information received from the DCA 320. In some embodiments of the NED 305, the IMU 340 may be a dedicated hardware component. In other embodiments, the IMU 340 may be a software component implemented in one or more processors.

In operation, a position sensor 335 generates one or more measurement signals in response to a motion of the NED 305. Examples of position sensors 335 include: one or more accelerometers, one or more gyroscopes, one or more magnetometers, one or more altimeters, one or more inclinometers, and/or various types of sensors for motion detection, drift detection, and/or error detection. The position sensors 335 may be located external to the IMU 340, internal to the IMU 340, or some combination thereof.

Based on the one or more measurement signals from one or more position sensors 335, the IMU 340 generates data indicating an estimated current position of the NED 305 relative to an initial position of the NED 305. For example, the position sensors 335 may include multiple accelerometers to measure translational motion (forward/back, up/down, left/right) and multiple gyroscopes to measure rotational motion (e.g., pitch, yaw, and roll). In some embodiments, the IMU 340 rapidly samples the measurement signals and calculates the estimated current position of the NED 305 from the sampled data. For example, the IMU 340 may integrate the measurement signals received from the accelerometers over time to estimate a velocity vector and integrates the velocity vector over time to determine an estimated current position of a reference point on the NED 305. Alternatively, the IMU 340 provides the sampled measurement signals to the console 310, which analyzes the sample data to determine one or more measurement errors. The console 310 may further transmit one or more of control signals and/or measurement errors to the IMU 340 to configure the IMU 340 to correct and/or reduce one or more measurement errors (e.g., drift errors). The reference point is a point that may be used to describe the position of the NED 305. The reference point may generally be defined as a point in space or a position related to a position and/or orientation of the NED 305.

In various embodiments, the IMU 340 receives one or more parameters from the console 310. The one or more parameters are used to maintain tracking of the NED 305. Based on a received parameter, the IMU 340 may adjust one or more IMU parameters (e.g., a sample rate). In some embodiments, certain parameters cause the IMU 340 to update an initial position of the reference point so that it corresponds to a next position of the reference point. Updating the initial position of the reference point as the next calibrated position of the reference point helps reduce drift errors in detecting a current position estimate of the IMU 340.

In some embodiments, the eye tracking system 345 is integrated into the NED 305. The eye-tracking system 345 may comprise one or more light sources and an imaging device (camera). In operation, the eye tracking system 345 generates and analyzes tracking data related to a user’s eyes as the user wears the NED 305. The eye tracking system 345 may further generate eye tracking information that may comprise information about a position of the user’s eye, i.e., information about an angle of an eye-gaze.

In some embodiments, the varifocal module 350 is further integrated into the NED 305. The varifocal module 350 may be communicatively coupled to the eye tracking system 345 in order to enable the varifocal module 350 to receive eye tracking information from the eye tracking system 345. The varifocal module 350 may further modify the focus of image light emitted from the display 325 based on the eye tracking information received from the eye tracking system 345. Accordingly, the varifocal module 350 can reduce vergence-accommodation conflict that may be produced as the user’s eyes resolve the image light. In various embodiments, the varifocal module 350 can be interfaced (e.g., either mechanically or electrically) with at least one optical element of the optical assembly 330.

In operation, the varifocal module 350 may adjust the position and/or orientation of one or more optical elements in the optical assembly 330 in order to adjust the focus of image light propagating through the optical assembly 330. In various embodiments, the varifocal module 350 may use eye tracking information obtained from the eye tracking system 345 to determine how to adjust one or more optical elements in the optical assembly 330. In some embodiments, the varifocal module 350 may perform foveated rendering of the image light based on the eye tracking information obtained from the eye tracking system 345 in order to adjust the resolution of the image light emitted by the display 325. In this case, the varifocal module 350 configures the display 325 to display a high pixel density in a foveal region of the user’s eye-gaze and a low pixel density in other regions of the user’s eye-gaze.

The I/O interface 315 facilitates the transfer of action requests from a user to the console 310. In addition, the I/O interface 315 facilitates the transfer of device feedback from the console 310 to the user. An action request is a request to perform a particular action. For example, an action request may be an instruction to start or end capture of image or video data or an instruction to perform a particular action within an application, such as pausing video playback, increasing or decreasing the volume of audio playback, and so forth. In various embodiments, the I/O interface 315 may include one or more input devices. Example input devices include: a keyboard, a mouse, a game controller, a joystick, and/or any other suitable device for receiving action requests and communicating the action requests to the console 310. In some embodiments, the I/O interface 315 includes an IMU 340 that captures calibration data indicating an estimated current position of the I/O interface 315 relative to an initial position of the I/O interface 315.

In operation, the I/O interface 315 receives action requests from the user and transmits those action requests to the console 310. Responsive to receiving the action request, the console 310 performs a corresponding action. For example, responsive to receiving an action request, the console 310 may configure the I/O interface 315 to emit haptic feedback onto an arm of the user. For example, the console 310 may configure the I/O interface 315 to deliver haptic feedback to a user when an action request is received. Additionally or alternatively, the console 310 may configure the I/O interface 315 to generate haptic feedback when the console 310 performs an action, responsive to receiving an action request.

The console 310 provides content to the NED 305 for processing in accordance with information received from one or more of: the DCA 320, the NED 305, and the I/O interface 315. As shown in FIG. 3, the console 310 includes an application store 355, a tracking module 360, and an engine 365. In some embodiments, the console 310 may have additional, fewer, or different modules and/or components than those described in conjunction with FIG. 3. Similarly, the functions further described below may be distributed among components of the console 310 in a different manner than described in conjunction with FIG. 3.

The application store 355 stores one or more applications for execution by the console 310. An application is a group of instructions that, when executed by a processor, performs a particular set of functions, such as generating content for presentation to the user. For example, an application may generate content in response to receiving inputs from a user (e.g., via movement of the NED 305 as the user moves his/her head, via the I/O interface 315, etc.). Examples of applications include: gaming applications, conferencing applications, video playback applications, or other suitable applications.

The tracking module 360 calibrates the NED system 300 using one or more calibration parameters. The tracking module 360 may further adjust one or more calibration parameters to reduce error in determining a position and/or orientation of the NED 305 or the I/O interface 315. For example, the tracking module 360 may transmit a calibration parameter to the DCA 320 in order to adjust the focus of the DCA 320. Accordingly, the DCA 320 may more accurately determine positions of structured light elements reflecting off of objects in the environment. The tracking module 360 may also analyze sensor data generated by the IMU 340 in determining various calibration parameters to modify. Further, in some embodiments, if the NED 305 loses tracking of the user’s eye, then the tracking module 360 may re-calibrate some or all of the components in the NED system 300. For example, if the DCA 320 loses line of sight of at least a threshold number of structured light elements projected onto the user’s eye, the tracking module 360 may transmit calibration parameters to the varifocal module 350 in order to re-establish eye tracking.

The tracking module 360 tracks the movements of the NED 305 and/or of the I/O interface 315 using information from the DCA 320, the one or more position sensors 335, the IMU 340 or some combination thereof. For example, the tracking module 360 may determine a reference position of the NED 305 from a mapping of an area local to the NED 305. The tracking module 360 may generate this mapping based on information received from the NED 305 itself. The tracking module 360 may also utilize sensor data from the IMU 340 and/or depth data from the DCA 320 to determine references positions for the NED 305 and/or I/O interface 315. In various embodiments, the tracking module 360 generates an estimation and/or prediction for a subsequent position of the NED 305 and/or the I/O interface 315. The tracking module 360 may transmit the predicted subsequent position to the engine 365.

The engine 365 generates a three-dimensional mapping of the area surrounding the NED 305 (i.e., the “local area”) based on information received from the NED 305. In some embodiments, the engine 365 determines depth information for the three-dimensional mapping of the local area based on depth data received from the DCA 320 (e.g., depth information of objects in the local area). In some embodiments, the engine 365 calculates a depth and/or position of the NED 305 by using depth data generated by the DCA 320. In particular, the engine 365 may implement various techniques for calculating the depth and/or position of the NED 305, such as stereo based techniques, structured light illumination techniques, time-of-flight techniques, and so forth. In various embodiments, the engine 365 uses depth data received from the DCA 320 to update a model of the local area and to generate and/or modify media content based in part on the updated model.

The engine 365 also executes applications within the NED system 300 and receives position information, acceleration information, velocity information, predicted future positions, or some combination thereof, of the NED 305 from the tracking module 360. Based on the received information, the engine 365 determines various forms of media content to transmit to the NED 305 for presentation to the user. For example, if the received information indicates that the user has looked to the left, the engine 365 generates media content for the NED 305 that mirrors the user’s movement in a virtual environment or in an environment augmenting the local area with additional media content. Accordingly, the engine 365 may generate and/or modify media content (e.g., visual and/or audio content) for presentation to the user. The engine 365 may further transmit the media content to the NED 305. Additionally, in response to receiving an action request from the I/O interface 315, the engine 365 may perform an action within an application executing on the console 310. The engine 365 may further provide feedback when the action is performed. For example, the engine 365 may configure the NED 305 to generate visual and/or audio feedback and/or the I/O interface 315 to generate haptic feedback to the user.

### Producing Glints and Iris Illumination for Eye Tracking

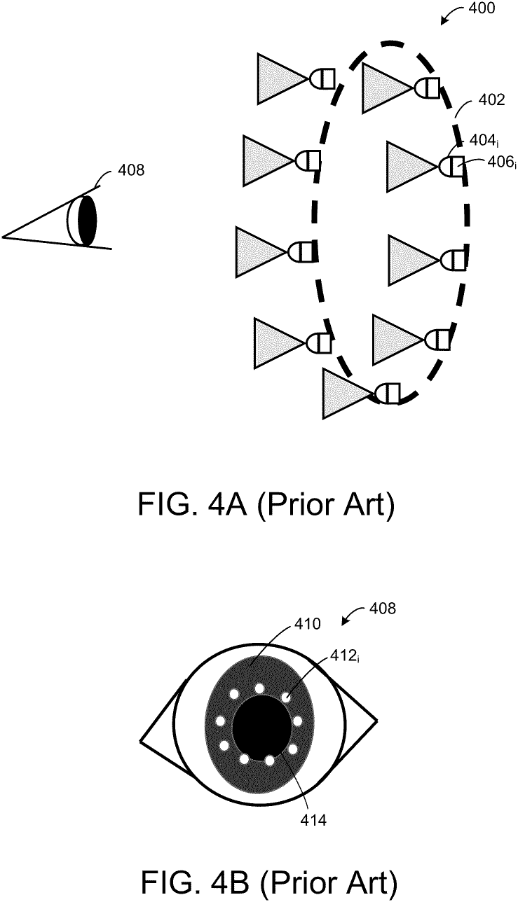

FIG. 4A illustrates a side view of an eye tracking system 400, according to the prior art. As shown, the eye tracking system 400 includes light sources 406ᵢ (referred to herein collectively as light sources 406 and individually as a light source 406) mounted around an eye 408 on a mounting eyecup 402. The eyecup 402 can surround a lens (not shown), through which content is displayed via a display device. In addition, the eye tracking system 400 includes packaged secondary optics 404ᵢ (referred to herein collectively as secondary optics 404 and individually as secondary optics 404) that are mounted on top of corresponding light sources 406. The light sources described herein, such as the light sources 406, can emit infrared light in some cases. For example, the light sources 406 could be light-emitting diodes (LEDs) that emit Lambertian light in the infrared spectrum. As used herein, Lambertian light refers to light that is emitted substantially uniformly in all directions. Lambertian light sources, such as LEDs, can provide flood illumination for distinguishing the pupil from the iris of an eye. However, Lambertian light sources do not produce glints that can be tracked over time. The secondary optics 404 are used to focus light emitted by the light sources 406 in order to generate glints. For example, the field of view (FOV) of light that is emitted by the light sources 406 and has passed through the secondary optics 404 can be approximately 100 degrees. In addition, stray light that is scattered onto the iris is used for flood illumination.

In addition, the eye tracking system 400 can include an imaging device (not shown) to capture images of the eye 408. Using the captured images, known techniques can be applied to monitor the locations of glints, as well as to detect a pupil of the eye 408, over time. The position of the pupil can then be tracked over time based on the glint positions and/or the detected pupil. For example, a signal-to-noise ratio and algorithm processing could be used to track the position of the pupil based on a combination of the glint positions and the detected pupil. As another example, a machine learning technique could be used to detect and track the pupil. One drawback of the eye tracking system 400 is the combination of the light sources 406 and the secondary optics 404 can be relatively large in size, causing the display device to be relatively far from the face of a viewer. As a result, the viewer can experience a reduced FOV of content being displayed. Another drawback of the eye tracking system 400 is that the combination of the light sources 406 and the secondary optics 404 do not typically generate sufficiently tightly-focused glints and sufficient flood illumination to enable accurate eye tracking and a desirable signal-to-noise ratio.

FIG. 4B illustrates exemplar glints and iris illumination generated by the eye tracking system 400 of FIG. 4A, according to the prior art. As shown, the secondary optics 404 cause light emitted by the light sources 406 to be semi-focused into glints 412ᵢ (referred to herein collectively as glints 412 and individually as a glint 412), rather than tightly-focused. The relatively large size of the semi-focused glints 412 reduces the location accuracy that is achievable when tracking the eye 408 using the eye tracking system 400. In addition, the semi-focused light scantily illuminates an iris 410 of the eye 408, providing poor contrast against a pupil 414 of the eye 408. As a result, the pupil 414 cannot be detected (i.e., distinguished from the iris 410) and tracked accurately.

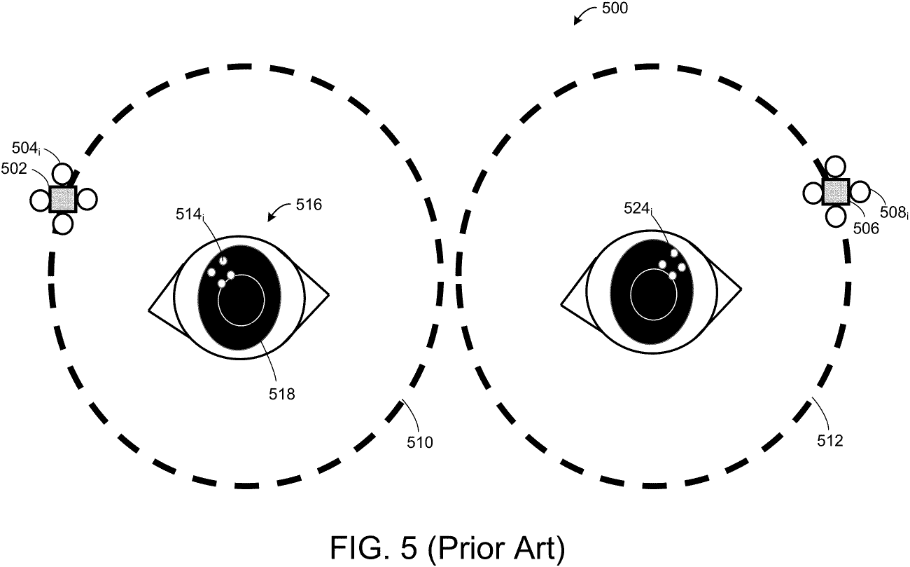

FIG. 5 illustrates a frontal view of another eye tracking system 500, according to the prior art. As shown, the eye tracking system 500 includes light sources 504ᵢ and 508ᵢ (referred to herein collectively as light sources 504 and 508 and individually as a light source 504 or 508) that are disposed on rings 510 and 512 around cameras 502 and 506, respectively. The light sources 504 and 508 generate glints 514ᵢ and 524ᵢ (referred to herein collectively as glints 514 and 524 and individually as a glint 514 or 524), respectively. The glints in images captured by the cameras 502 and 506 can be used to detect the pupil of each eye, such as pupil 518 of eye 516, as described above in conjunction with FIG. 4A. In addition, an optical axis can be obtained using known techniques by connecting a corneal center and a pupil center using a virtual pupil. In such cases, a pupil (e.g. the pupil 518) can be tracked by finding the center of the eyeball, without directly following the pupil, using the optical axis/virtual pupil and triangulation between the glint on the eye, virtual pupil, and cameras (e.g., cameras 502 or 506) that are collocated with light sources (e.g., light source 504 or 508). The iris of each eye does not need to be illuminated if the glints 514 or 524 alone are used to track the eye.

FIG. 6A illustrates a side view of an eye tracking system 600, according to various embodiments. As shown, in the eye tracking system 600, compact Lambertian light sources 604ᵢ (referred to herein collectively as light sources 604 and individually as a light source 604) are mounted on an eyecup 602 around an eye 608. In some embodiments, each light source 604 can include an LED, a superluminescent diode (SLED), or a resonant cavity LED. Any technically feasible number of light sources 604 that form a ring can be used in some embodiments. The light sources described herein, including the light sources 604, can emit infrared light in some embodiments. In some embodiments, the emission cone of each light source 604 is approximately 120-140 degrees, depending on the epi Illustratively, diffusers 606ᵢ (referred to herein collectively as diffusers 606 and individually as a diffuser 606) over corresponding light sources 604 can further scatter the emitted light, while not increasing the size of the package that includes the diffuser 606 and the light source 604. For example, in some embodiments, the diffusers 606 and the light sources 604 can be Lambertian emitters with diffuser structured silicon encapsulation.

FIG. 6B illustrates exemplar glints and iris 612 illumination generated by the eye tracking system 600 of FIG. 6A, according to various embodiments. As shown, the eye tracking system 600 generates a significant amount of flood illumination, which can provide sufficient contrast in captured images for a pupil 616 of the eye 608 to be detected. The images can be captured by any technically feasible configuration of camera(s), such as camera(s) that are located along the same plane as the light sources 604; to the side around the nasal, temporal area; and/or behind the lens on the opposite side of the eye 608.

In addition, the eye tracking system 600 generates relatively dimmer glints, such as glint 614. Accordingly, using captured images, known techniques can be applied to monitor the locations of glints, as well as to detect the pupil 616, over time. The position of the pupil 616 can then be tracked over time based on the glint positions and/or the detected pupil 616, as described above in conjunction with FIG. 4A.

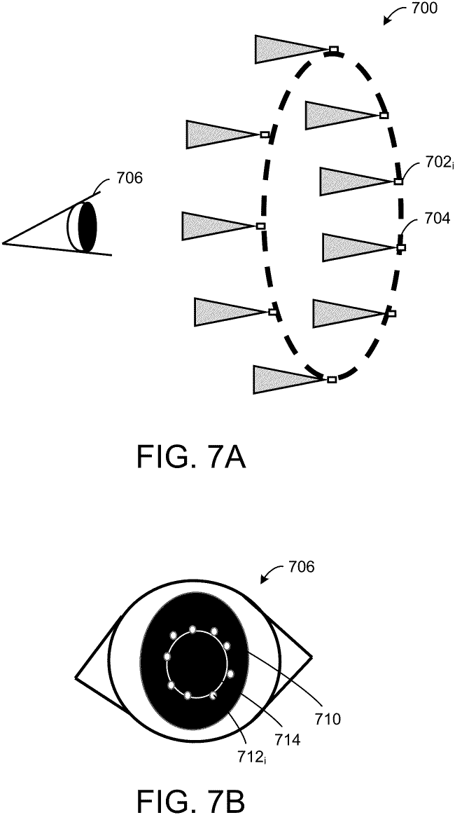

FIG. 7A illustrates a side view of an eye tracking system 700, according to various other embodiments. As shown, in the eye tracking system 700, narrow FOV light sources 702ᵢ (referred to herein collectively as light sources 702 and individually as a light source 702) are mounted on an eyecup 704 around an eye 706. In some embodiments, each light source 702 can include a laser, a VCSEL, or a PCSEL. In some embodiments, each light source 702 has single mode and a narrow FOV of 5-50 degrees. In some embodiments, the light sources 702 are ultra-low power (e.g., .5-2 mW), and therefore the divergence of light beams emitted by the light sources 702 will be on the high end. The aperture size drives the divergence, and if the aperture size is too large, then the device becomes multimodal. Any technically feasible number of light sources 702 (e.g., 9-12 light sources 702) that form a ring can be used in some embodiments. Notably, no secondary optics are required to narrow the beam emitted by any light source 702, because as the light sources 702 are naturally tightly focused. As a result, a display device (not shown) can be closer to the face of a viewer relative to a display device that is used in conjunction with the eye tracking system 400 of FIG. 4A, and the viewer can experience a wider FOV of content being displayed.

FIG. 7B illustrates exemplar glints and iris illumination generated by the eye tracking system 700 of FIG. 7A, according to various embodiments. As shown, the eye tracking system 700 generates a ring of glints 712ᵢ (referred to herein collectively as glints 712 and individually as a glint 712) that are relatively sharp due to the tightly focused beams emitted by the light sources 702. However, the light sources 702 do not provide much flood illumination, so there can be relatively poor contrast between an iris 714 and a pupil 710 of the eye 706 in images captured by one or more cameras. Similar to the discussion above in conjunction with FIG. 6B, the images can be captured by any technically feasible configuration of camera(s), such as camera(s) that are located along the same plane as the light sources 702; to the side around the nasal, temporal area; and/or behind the lens on the opposite side of the eye 706. Using the captured images, known techniques can be applied to monitor locations of the glints 712 overtime, and the position of the pupil 710 can then be tracked based on the glint 712 positions, as described above in conjunction with FIG. 4A. Additionally or alternatively, in some embodiments, cameras (not shown) that are collocated with the light sources 702 can be used to capture images that are used to track a pupil by finding the center of the eyeball via triangulation, as described above in conjunction with FIG. 5.

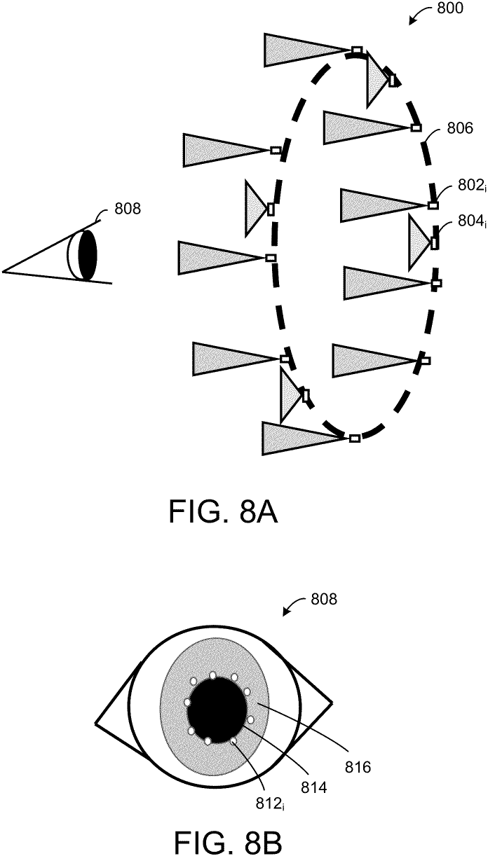

FIG. 8A illustrates a side view of an eye tracking system 800, according to various other embodiments. As shown, in the eye tracking system 800, narrow FOV light sources 802ᵢ (referred to herein collectively as light sources 802 and individually as a light source 802) and Lambertian light sources 804ᵢ (referred to herein collectively as light sources 804 and individually as a light source 804) are mounted on an eyecup 806 around an eye 808. Any technically feasible number of light sources 802 and 804 that form a ring can be used in some embodiments. In some embodiments, the narrow FOV light sources 802 are similar to the narrow FOV light sources 702, described above in conjunction with FIG. 7A, and the Lambertian light sources 804 are similar to the Lambertian light sources 604, described above in conjunction with FIG. 6A. Notably, no secondary optics are used in conjunction with the light sources 802 or 804. As a result, a display device (not shown) can be closer to the face of a viewer relative to a display device that is used in conjunction with the eye tracking system 400 of FIG. 4A, and the viewer can experience a wider FOV of content being displayed.

FIG. 8B illustrates exemplar glints and iris illumination generated by the eye tracking system 800 of FIG. 8A, according to various embodiments. As shown, the eye tracking system 800 generates sufficient flood illumination to provide a relatively high contrast between an iris 816 and a pupil 814 of the eye 808 in images captured by one or more cameras. Similar to the discussion above in conjunction with FIG. 6B, the images can be captured by any technically feasible configuration of camera(s), such as camera(s) that are located along the same plane as the light sources 802 and 804; to the side around the nasal, temporal area; and/or behind the lens on the opposite side of the eye 808.

In addition, the eye tracking system 800 generates a ring of glints 812ᵢ (referred to herein collectively as glints 812 and individually as a glint 812) that are relatively sharp due to the tightly focused beams emitted by the light sources 802. Accordingly, using captured images, known techniques can be applied to monitor the locations of the glints 812, as well as to detect the pupil 814, over time. The position of the pupil 814 can then be tracked over time based on the glint 812 positions and/or the detected pupil 814, as described above in conjunction with FIG. 4A. Additionally or alternatively, in some embodiments, cameras (not shown) that are collocated with the light sources 802 can be used to capture images that are used to track a pupil by finding the center of the eyeball via triangulation, as described above in conjunction with FIG. 5.

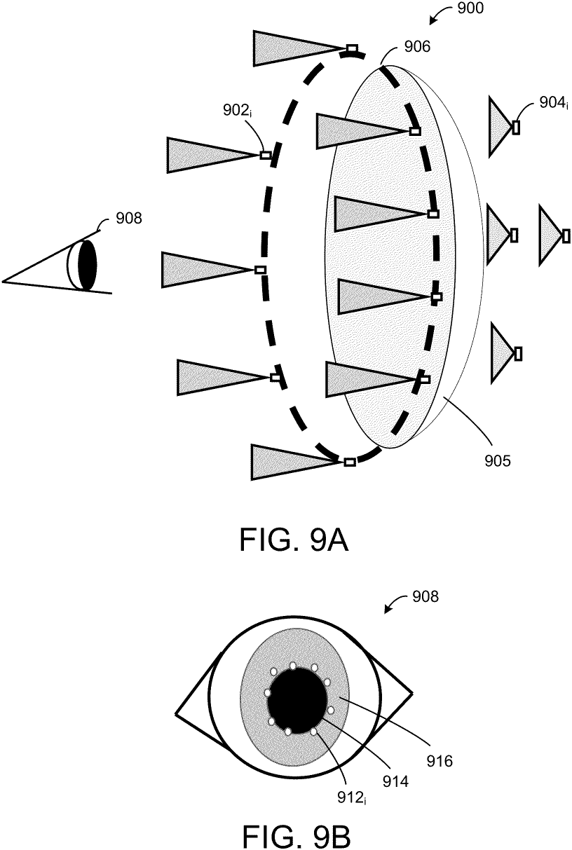

FIG. 9A illustrates a side view of an eye tracking system 900, according to various other embodiments. As shown, in the eye tracking system 900, narrow FOV light sources 902ᵢ (referred to herein collectively as light sources 902 and individually as a light source 902) are mounted on an eyecup 906 around an eye 908. In addition, Lambertian light sources 904ᵢ (referred to herein collectively as light sources 904 and individually as a light source 904) are disposed behind a lens 905 in a direction away from the viewer. Any technically feasible number of light sources 902 and 904 that form rings can be used in some embodiments. In some embodiments, the narrow FOV light sources 902 and the Lambertian light sources 904 are similar to the narrow FOV light sources 802 and the Lambertian light sources 804, respectively, described above in conjunction with FIG. 8A. Additional space is saved relative to the eye tracking system 800 of FIG. 8A by placing the Lambertian light sources 904 behind the lens 905.

FIG. 9B illustrates exemplar glints and iris 916 illumination generated by the eye tracking system 900 of FIG. 9A, according to various embodiments. As shown, the eye tracking system 900 generates flood illumination and a ring of glints 912ᵢ (referred to herein collectively as glints 912 and individually as a glint 912) that are similar to the flood illumination and glints 812 generated by the eye tracking system 800, described above in conjunction with FIG. 8B. Using captured images, known techniques can be applied to monitor the locations of the glints 912, as well as to detect a pupil 914 of the eye 908, over time. Similar to the discussion above in conjunction with FIG. 6B, the images can be captured by any technically feasible configuration of camera(s), such as camera(s) that are located along the same plane as the light sources 902; to the side around the nasal, temporal area; and/or behind the lens 905 on the opposite side of the eye 908. The position of the pupil 914 can be tracked over time based on the glint 912 positions and/or the detected pupil 914, as described above in conjunction with FIG. 4A. Additionally or alternatively, in some embodiments, cameras (not shown) that are collocated with the light sources 902 can be used to capture images that are used to track a pupil by finding the center of the eyeball via triangulation, as described above in conjunction with FIG. 5.

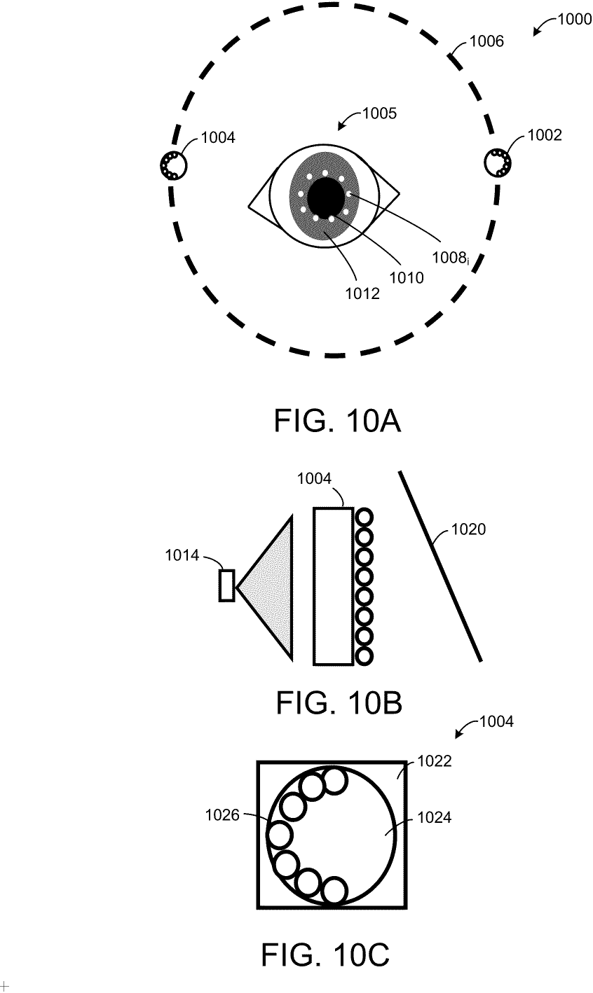

FIG. 10A illustrates a frontal view of an eye tracking system 1000, according to various other embodiments. As shown, the eye tracking system 1000 includes Lambertian light sources (not shown) mounted under multilens arrays 1002 and 1004 (also referred to herein as lenslet arrays 1002 and 1004) on an eye cup 1006 surrounding an eye 1005. In some embodiments, the light sources and multilens arrays 1002 and 1004 can be folded into the eye cup 1006 using a mirror.

FIG. 10B illustrates in greater detail a side view of a light source and the lenslet array 1004 of the eye tracking system 1000 of FIG. 10A, according to various embodiments. As shown, a Lambertian light source 1014 emits light that passes through the multilens array 1004 and is reflected by a mirror 1020. As described, the mirror permits the light source 1014 and the multilens array 1004 to be folded into the eye cup 1006.

FIG. 10C illustrates in greater detail a top view of the lenslet array 1004 of the eye tracking system 1000 of FIG. 10A, according to various embodiments. As shown, the lenslet array 1004 includes a flat portion 1024, through which some light emitted by the light source 1014 will pass through as Lambertian, thereby providing flood illumination of the eye 1005. In addition, the lenslet array 1004 includes lenslets 1026 in a semicircle that generate glints in a semi-circle. Together with an opposite semi-circle of glints generated by the lenslet array 1002, a ring of glints 1008ᵢ (referred to herein collectively as glints 1008 and individually as a glint 1008) is generated. It should be noted that the glints 1008 may not be as tightly focused as the glints 712 and 812, described above in conjunction with FIGS. 7 and 8, respectively. Although the glints 1008 are somewhat larger glints, the alignment of glint illumination around the eye 1005 is reduced by using the multilens array 1004 that only requires mounting one multi-lensed optic, as each lenslet 1026 accounts for tolerance as opposed to individual lenses placements, described above in conjunction with FIGS. 7 and 8. It should be noted the location of each glint 1008 is determined by the pointing angle and lens location on each light source around the eye 1005 and subject to manufacturing tolerances as well as mounting tolerances. Additionally, in some embodiments, the eye tracking system 1000 can be employed in conjunction with an image processing technique that does not require 360 degree coverage of the eye 1005. For example, in some embodiments, the image processing technique can be based on a center location of the eye 1005 instead of pure glint tracking, as described above in conjunction with FIG. 5. Notably, glint coverage is not required 360 degrees around the eye 1005, i.e., partial glint coverage and iris 1012 contrast can be used to track a pupil 1010. Similar to the discussion above in conjunction with FIG. 6B, images of the eye 1005 can be captured by any technically feasible configuration of camera(s), such as camera(s) that are located along the same plane as the light sources 1014; to the side around the nasal, temporal area; and/or behind the lens on the opposite side of the eye 1005.

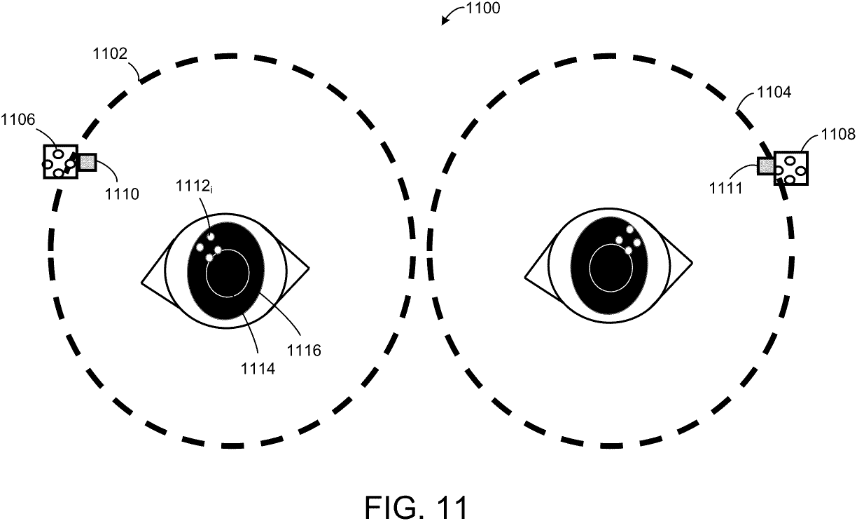

FIG. 11 illustrates a frontal view of an eye tracking system, according to various other embodiments. As shown, arrays of light sources 1106 and 1108 are collocated around cameras 1110 and 1111, respectively. The arrays of light sources 1106 and 1108 can be located as close as possible to the cameras 1110 and 1111, respectively, in some embodiments. In some embodiments, the arrays of light sources 1106 and 1108 include narrow FOV light sources, such as lasers, VCSELs, or PCSELs. Illustratively, the arrays of light sources 1106 and 1108 generate glints, such as glints 1112ᵢ (referred to herein collectively as glints 1112 and individually as a glint 1112), that are relatively sharp due to the tightly focused beams emitted by the arrays of light sources 1106 and 1108. Accordingly, using captured images, known techniques can be applied to monitor the locations of the glints over time, and the positions of the pupils can then be tracked over time based on the glint locations. In some embodiments, triangulation pupil tracking techniques can be used to track the pupils (e.g., pupil 1114 in iris 1116) based on the locations of the glints, as described above in conjunction with FIG. 5. Notably, glint coverage is not required 360 degrees around an eye, i.e., partial glint coverage and iris contrast can be used to track the pupil.

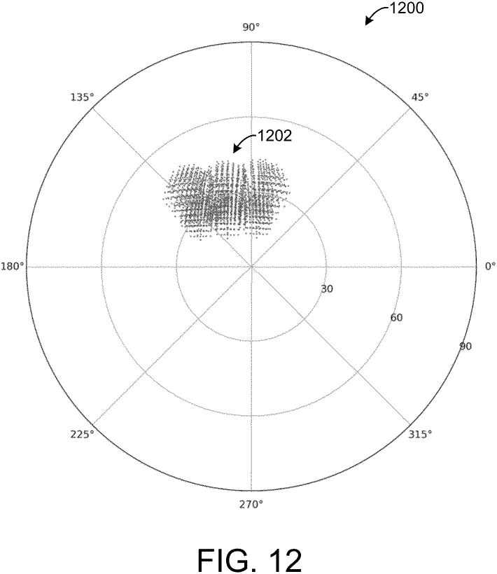

FIG. 12 illustrates simulated angular positions 1200 of glints relative to a light source, according to various embodiments. As shown, with the eye tracking system 1100 described above in conjunction with FIG. 11, a small cone can cover all areas 1202 of an eye that need glints for pupil tracking after calibration/aiming. Accordingly, the eye tracking system 1100 can be used to track the pupil of an eye over time using the glints described above in conjunction with FIG. 11.

One advantage of the eye tracking systems disclosed herein is that the eye tracking systems are more compact relative to conventional eye tracking systems. Accordingly, the disclosed eye tracking systems permit a display of an artificial reality system, such as an HMD, to be relatively close to the face of a viewer. Accordingly, the viewer can experience a larger FOV of content being displayed relative to artificial reality systems that include conventional eye tracking systems. In addition, some of the disclosed eye tracking systems produce more tightly-focused glints in conjunction with flood illumination relative to conventional eye tracking systems. Using the tightly-focused glints and the flood illumination, the eyes of a viewer can be tracked more accurately and/or with a better signal-to-noise ratio. These technical advantages represent one or more technological advancements over prior art approaches.

1. In some embodiments, an eye tracking system comprises one or more cameras, and one or more light sources configured to illuminate an eye, wherein either (i) at least one of a lenslet array or a diffuser is disposed in a path of light emitted by each light source included in the one or more light sources, or (ii) the path of light emitted by each light source included in the one or more light sources is unobstructed by any optical elements.

2. The eye tracking system of clause 1, wherein each light source included in the one or more light sources comprises a light-emitting diode (LED), a superluminescent diode (SLED), a resonant cavity LED, a laser, a vertical-cavity surface-emitting laser (VCSEL), or a photonic crystal surface emitting laser (PCSEL).

3. The eye tracking system of clauses 1 or 2, wherein the one or more light sources include one or more first light sources, each first light source generating substantially uniform light in a plurality of directions, and one or more second light sources, each second light source generating a narrower field of view (FOV) light beam relative to each first light source.

4. The eye tracking system of any of clauses 1-3, wherein a lenslet array is disposed in the path of light emitted by each light source included in the one or more light sources, and the eye tracking system further comprises one or more fold mirrors corresponding to the one or more light sources.

5. The eye tracking system of any of clauses 1-4, further comprising one or more processors, wherein the one or more processors are configured to perform at least one of one or more optical axis tracking operations or one or more virtual pupil tracking operations based on a plurality of images captured by the one or more cameras.

6. The eye tracking system of any of clauses 1-5, wherein the one or more light sources are mounted on an eyecup.

7. The eye tracking system of any of clauses 1-6, wherein a first set of light sources included in the one or more light sources are disposed adjacent to a first camera included in the one or more cameras.

8. The eye tracking system of any of clauses 1-7, further comprising a processor configured to perform at least one of one or more optical axis operations or one or more virtual pupil tracking operations based on a plurality of images captured by the one or more cameras.

9. The eye tracking system of any of clauses 1-8, further comprising one or more processors, wherein the one or more processors are configured to track the eye based on at least one of a plurality of glints generated via the one or more light sources or an iris illumination generated by the one or more light sources.

10. In some embodiments, a head-mounted display (HMD) comprises an electronic display, and an eye tracking system, the eye tracking system comprising one or more light sources configured to illuminate an eye, wherein either (i) at least one of a lenslet array or a diffuser is disposed in a path of light emitted by each light source included in the one or more light sources, or (ii) the path of light emitted by each light source included in the one or more light sources is unobstructed by any optical elements.

11. The HMD of clause 10, wherein the eye tracking system further comprises one or more cameras.

12. The HMD of clauses 10 or 11, wherein each light source included in the one or more light sources comprises a light-emitting diode (LED), a superluminescent diode (SLED), a resonant cavity LED, a laser, a vertical-cavity surface-emitting laser (VCSEL), or a photonic crystal surface emitting laser (PCSEL).

13. The HMD of any of clauses 10-12, wherein the one or more light sources include one or more first light sources, each first light source generating substantially uniform light in a plurality of directions, and one or more second light sources, each second light source generating a narrower field of view (FOV) light beam relative to each first light source.

14. The HMD of any of clauses 10-13, wherein a lenslet array is disposed in the path of light emitted by each light source included in the one or more light sources, and the eye tracking system further comprises one or more fold mirrors corresponding to the one or more light sources.

15. The HMD of any of clauses 10-14, further comprising a processor configured to perform at least one of one or more optical axis operations or one or more virtual pupil tracking operations based on a plurality of images captured by one or more cameras.

16. The HMD of any of clauses 10-15, wherein the one or more light sources are mounted on an eyecup.

17. The HMD of any of clauses 10-16, wherein a first set of light sources included in the one or more light sources are disposed adjacent to a camera.

18. The HMD of any of clauses 10-17, further comprising a lens, wherein at least one light source included in the one or more light sources is disposed behind the lens in a direction relative to an eye.

19. In some embodiments, an eye tracking system comprises one or more cameras, one or more first light sources, each first light source generating substantially uniform light in a plurality of directions, and one or more second light sources, each second light source generating a narrower field of view (FOV) light beam relative to each first light source.

20. The eye tracking system of clause 19, wherein each first light source comprises a light-emitting diode (LED), a superluminescent diode (SLED), or a resonant cavity LED, and each first light source comprises a laser, a vertical-cavity surface-emitting laser (VCSEL), or a photonic crystal surface emitting laser (PCSEL).

Any and all combinations of any of the claim elements recited in any of the claims and/or any elements described in this application, in any fashion, fall within the contemplated scope of the present disclosure and protection.

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

The descriptions of the various embodiments have been presented for purposes of illustration, but are not intended to be exhaustive or limited to the embodiments disclosed. Many modifications and variations is apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a ““module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It is understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. An eye tracking system, comprising:
one or more cameras; and
one or more light sources configured to illuminate an eye,
wherein either (i) at least one of a lenslet array or a diffuser is disposed in a path of light emitted by each light source included in the one or more light sources, or (ii) the path of light emitted by each light source included in the one or more light sources is unobstructed by any optical elements.

2. The eye tracking system of claim 1, wherein each light source included in the one or more light sources comprises a light-emitting diode (LED), a superluminescent diode (SLED), a resonant cavity LED, a laser, a vertical-cavity surface-emitting laser (VCSEL), or a photonic crystal surface emitting laser (PCSEL).

3. The eye tracking system of claim 1, wherein the one or more light sources include:
one or more first light sources, each first light source generating substantially uniform light in a plurality of directions; and
one or more second light sources, each second light source generating a narrower field of view (FOV) light beam relative to each first light source.

4. The eye tracking system of claim 1, wherein a lenslet array is disposed in the path of light emitted by each light source included in the one or more light sources, and the eye tracking system further comprises:
one or more fold mirrors corresponding to the one or more light sources.

5. The eye tracking system of claim 4, further comprising one or more processors, wherein the one or more processors are configured to perform at least one of one or more optical axis tracking operations or one or more virtual pupil tracking operations based on a plurality of images captured by the one or more cameras.

6. The eye tracking system of claim 1, wherein the one or more light sources are mounted on an eyecup.

7. The eye tracking system of claim 1, wherein a first set of light sources included in the one or more light sources are disposed adjacent to a first camera included in the one or more cameras.

8. The eye tracking system of claim 1, further comprising a processor configured to perform at least one of one or more optical axis operations or one or more virtual pupil tracking operations based on a plurality of images captured by the one or more cameras.

9. The eye tracking system of claim 1, further comprising one or more processors, wherein the one or more processors are configured to track the eye based on at least one of a plurality of glints generated via the one or more light sources or an iris illumination generated by the one or more light sources.

10. A head-mounted display (HMD), comprising:
an electronic display; and
an eye tracking system, the eye tracking system comprising:
one or more light sources configured to illuminate an eye,
wherein either (i) at least one of a lenslet array or a diffuser is disposed in a path of light emitted by each light source included in the one or more light sources, or (ii) the path of light emitted by each light source included in the one or more light sources is unobstructed by any optical elements.

11. The HMD of claim 10, wherein the eye tracking system further comprises one or more cameras.

12. The HMD of claim 10, wherein each light source included in the one or more light sources comprises a light-emitting diode (LED), a superluminescent diode (SLED), a resonant cavity LED, a laser, a vertical-cavity surface-emitting laser (VCSEL), or a photonic crystal surface emitting laser (PCSEL).

13. The HMD of claim 10, wherein the one or more light sources include:
one or more first light sources, each first light source generating substantially uniform light in a plurality of directions; and
one or more second light sources, each second light source generating a narrower field of view (FOV) light beam relative to each first light source.

14. The HMD of claim 10, wherein a lenslet array is disposed in the path of light emitted by each light source included in the one or more light sources, and the eye tracking system further comprises:
one or more fold mirrors corresponding to the one or more light sources.

15. The HMD of claim 10, further comprising a processor configured to perform at least one of one or more optical axis operations or one or more virtual pupil tracking operations based on a plurality of images captured by one or more cameras.

16. The HMD of claim 10, wherein the one or more light sources are mounted on an eyecup.

17. The HMD of claim 10, wherein a first set of light sources included in the one or more light sources are disposed adjacent to a camera.

18. The HMD of claim 10, further comprising:
a lens,
wherein at least one light source included in the one or more light sources is disposed behind the lens in a direction relative to an eye.

19. An eye tracking system, comprising:
one or more cameras;
one or more first light sources, each first light source generating substantially uniform light in a plurality of directions; and
one or more second light sources, each second light source generating a narrower field of view (FOV) light beam relative to each first light source.

20. The eye tracking system of claim 19, wherein:
each first light source comprises a light-emitting diode (LED), a superluminescent diode (SLED), or a resonant cavity LED; and
each first light source comprises a laser, a vertical-cavity surface-emitting laser (VCSEL), or a photonic crystal surface emitting laser (PCSEL).
